(19) United States
(12) Patent Application Publication
(10) Pub. No.: US 2025/0296817 A1
(43) Pub. Date: Sep. 25, 2025

(54) WORK MACHINE

(71) Applicant: TADANO LTD, Kagawa (JP)

(72) Inventors: Manato SHIRAI, Kagawa (JP); Masahide ZUSHI, Kagawa (JP); Masahito TOSHIRO, Kagawa (JP)

(73) Assignee: TADANO LTD, Kagawa (JP)

(21) Appl. No.: 18/868,787

(22) PCT Filed: Jun. 13, 2023
(86) PCT No.: PCT/JP2023/021971

§ 371 Date: Nov. 25, 2024

(30) Foreign Application Priority Data
Jun. 17, 2022 (JP) 2022-098298

(51) Int. Cl. B66C 23/88; B66C 23/70

(52) U.S. Cl. CPC B66C 23/88; B66C 23/705

(57) ABSTRACT

This work machine includes: a plurality of booms that extend and contract by means of power of an actuator; a boom coupling pin which is supported by the booms, moves in the entering direction by means of a spring to turn into an entering state in which adjacent booms are coupled, and moves in the pulling direction by means of power of a motor to turn into a pulling state in which the coupling is released; and a manual operation member inserted into the boom coupling pin and disposed coaxially with the boom coupling pin. As the manual operation member rotates on the basis of the manual operation of an operator, the boom coupling pin moves in the pulling direction together with the manual operation member, and the coupling between adjacent booms is released.

### TECHNICAL FIELD

The present invention relates to a work machine equipped with a telescopic boom.

### BACKGROUND ART

Patent Literature 1 discloses a mobile crane that includes: a telescopic boom in which a plurality of booms are stacked in a nested structure; and a hydraulic actuator (telescopic cylinder) that extends the telescopic boom.

The adjacent booms are coupled together with coupling pins. Once the coupling between the booms with the coupling pins is released, the booms are movable relative to one another in the extending and shortening direction (those booms are referred to below as the movable booms).

The actuator is coupled to the movable booms via coupling pins. When the actuator moves in the extending and shortening direction in this state, the boom that is movable together with the actuator moves so that the telescopic boom extends and shortens.

### CITATION LIST

### Patent Literature

Patent Literature 1: JP 2012-96928 A

### SUMMARY OF THE INVENTION

### Problems to be Solved by the Invention

If a mechanism for coupling adjacent booms breaks in a crane as described above, the crane may fail to release the coupling between the booms, in which case the telescopic boom can no longer contract.

An object of the present invention is to provide a work machine equipped with a mechanism by which the coupling between adjacent booms can be manually released.

### Solutions to Problems

An aspect of a work machine according to the present invention includes:
a plurality of booms that extend and shorten by power of an actuator;
a boom coupling pin that is moved in an insertion direction by a spring to turn into an insertion state where adjacent ones of the booms make a coupling with each other and that is moved in a removal direction by power of a motor to turn into a removal state where the coupling is released, the boom coupling pin being supported by the booms; and
a manual operation member that is inserted into and passes through the boom coupling pin, the manual operation member being disposed coaxially with the boom coupling pin, in which
when the manual operation member is rotated based on an operator's manual operation, the boom coupling pin moves in the removal direction together with the manual operation member to release the coupling between the adjacent booms.

### Effects of the Invention

The present invention can provide a work machine equipped with a mechanism by which the coupling between adjacent booms can be manually released.

### BRIEF DESCRIPTION OF DRAWINGS

FIG. 1 is a schematic view of a mobile crane according to an embodiment.

FIG. 2A is a schematic view for illustrating a structure and extending/shortening movement of a telescopic boom.

FIG. 2B is the schematic view for illustrating the structure and extending/shortening movement of the telescopic boom.

FIG. 2C is the schematic view for illustrating the structure and extending/shortening movement of the telescopic boom.

FIG. 2D is the schematic view for illustrating the structure and extending/shortening movement of the telescopic boom.

FIG. 2E is the schematic view for illustrating the structure and extending/shortening movement of the telescopic boom.

FIG. 3 is a schematic view for illustrating the structure of the telescopic boom.

FIG. 4 is a cross-sectional view of a pin-moving mechanism in a state where a boom coupling mechanism contracts.

FIG. 5A is an enlarged cross-sectional view of section X in FIG. 4, which illustrates a state where a boom coupling pin is inserted.

FIG. 5B is an enlarged cross-sectional view of section X in FIG. 4, which illustrates a state where the boom coupling pin is removed by a manual operation.

FIG. 6 is a perspective view of the boom coupling pin.

FIG. 7A is a schematic view for illustrating an operation of the cylinder coupling mechanism.

FIG. 7B is a schematic view for illustrating the operation of the cylinder coupling mechanism.

FIG. 7C is a schematic view for illustrating the operation of the cylinder coupling mechanism.

FIG. 8A is a schematic view for illustrating the operation of the boom coupling mechanism.

FIG. 8B is a schematic view for illustrating the operation of the boom coupling mechanism.

FIG. 8C is a schematic view for illustrating the operation of the boom coupling mechanism.

### DESCRIPTION OF EMBODIMENTS

Hereinafter, an example of an embodiment of the present invention will be described in detail with reference to the accompanying drawings. It should be noted that a crane according to the embodiment which will be described below corresponds to an example of a work machine according to the present invention, and the present invention is not limited to the embodiments described below.

### Embodiment

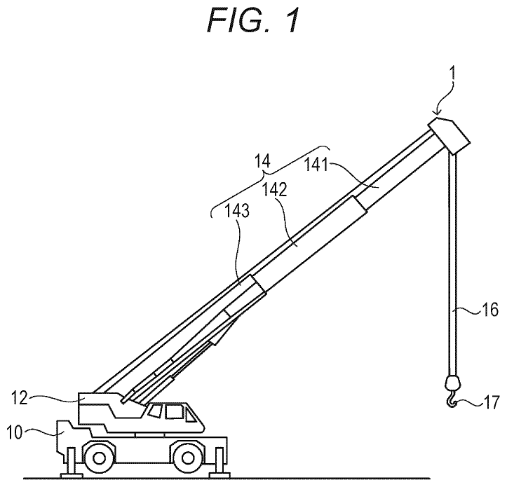

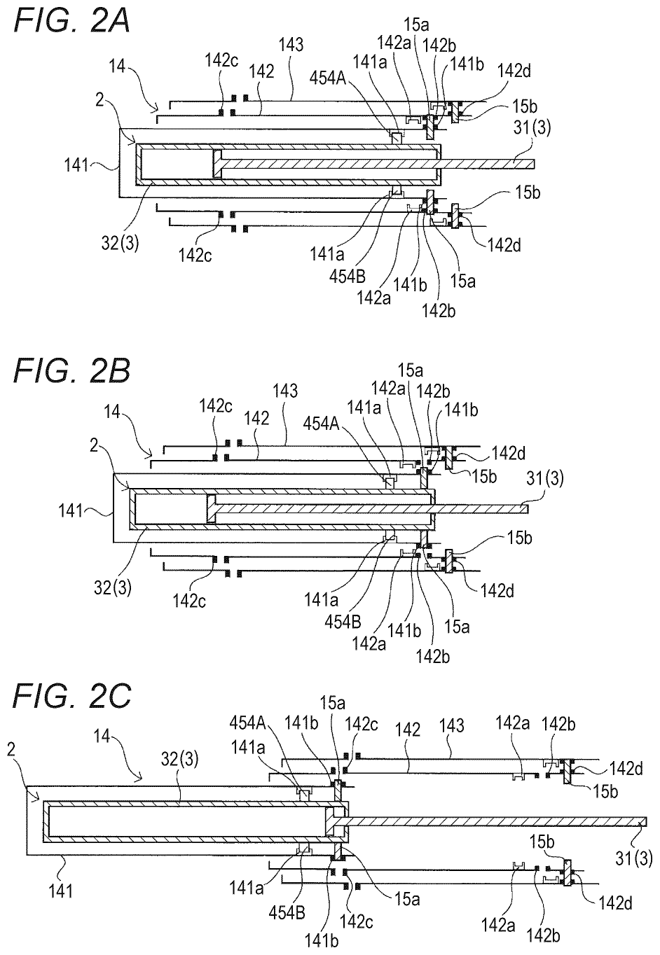

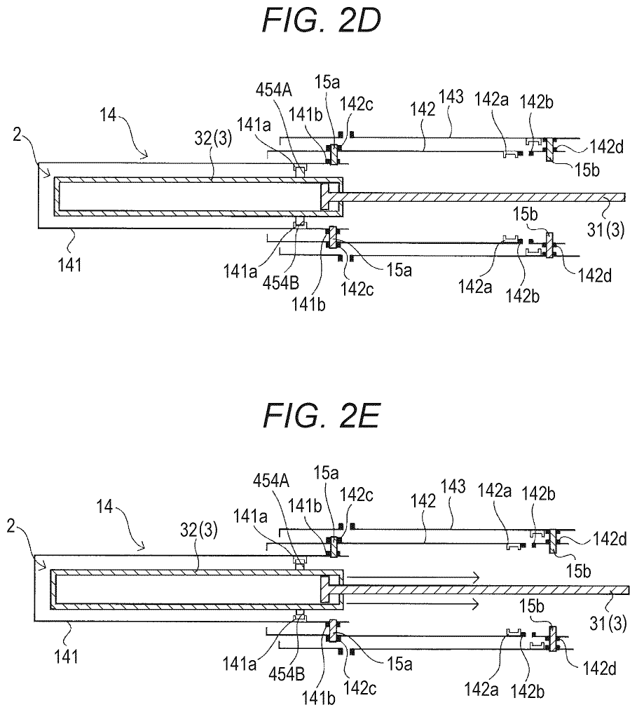

An outline of a mobile crane 1 according to the present embodiment will be described with reference to FIG. 1 and FIGS. 2A to 2E.

The mobile crane is, for example, a rough terrain crane, an all-terrain crane, a truck crane, or a truck loader crane. However, the work machine is not limited to such a mobile crane and may be any other work machine (e.g., a high-place work vehicle) equipped with a telescopic boom.

The mobile crane 1 includes a telescopic boom 14 and an actuator 2. The telescopic boom 14 includes a plurality of booms that have been assembled so as to be able to extend and shorten. Adjacent booms are coupled together by boom coupling pins 15a and 15b.

The actuator 2 moves booms in the extending or shortening direction when extending/shortening the telescopic boom 14. In this case, the actuator 2 is coupled to a boom being moved via cylinder coupling pins 454A and 454B and releases the coupling between the moved boom and a boom adjacent to the moved boom.

During the extending or shortening operation of the telescopic boom 14, the boom coupling pins 15a and 15b are moved by the power of an electric motor 41 to release the coupling between the adjacent booms. In this case, if any trouble occurs in the electric motor 41, the electric motor 41 may be unable to move the boom coupling pins 15a and 15b, thereby failing to release the coupling between the adjacent booms. For this reason, the mobile crane 1 includes a unit (releasing unit) that releases the coupling between the adjacent booms by allowing the boom coupling pins 15a and 15b to be manually moved. Hereinafter, the configuration of the mobile crane 1 according to the present embodiment will be specifically described.

As illustrated in FIGS. 1 and 2A to 2E, the mobile crane 1 includes a traveling body 10, a turning table 12, the telescopic boom 14, the actuator 2, a wire rope 16, and a hook 17.

The turning table 12 is provided over the traveling body 10. The telescopic boom 14 is fixed at its proximal end to the turning table 12 and can rise/fall and extend/shorten. The actuator 2 extends or shortens the telescopic boom 14. The wire rope 16 is supported by the telescopic boom 14 and hangs down from a distal end of the telescopic boom 14. The hook 17 is provided at a distal end of the wire rope 16.

Next, the telescopic boom 14 will be described. The telescopic boom 14 has a plurality of booms that have been assembled together in a telescopic manner. Specifically, the plurality of booms include a distal end boom 141, an intermediate boom 142, and a proximal end boom 143, which are disposed in order from the inner side.

The telescopic boom 14 transitions from the contracting state illustrated in FIG. 2A to the extending state illustrated in FIG. 1 by sequentially extending the booms in order from the boom disposed on the inner side. A plurality of intermediate booms may be provided.

The distal end boom 141 includes a pair of cylinder pin receiving sections 141a and a pair of boom pin receiving sections 141b at its proximal end. The pair of cylinder pin receiving sections 141a are provided coaxially with each other at the proximal end of the distal end boom 141. The pair of cylinder pin receiving sections 141a can engage with and disengage from, respectively, the pair of cylinder coupling pins 454A and 454B provided in a cylinder member 32 (movable-side member) of a telescopic cylinder 3.

The distal end boom 141 can move in the extending and shortening direction together with the cylinder member 32, with the pair of cylinder coupling pins 454A and 454B engaging with the pair of cylinder pin receiving sections 141a.

The pair of boom pin receiving sections 141b are provided coaxially with each other near the cylinder pin receiving sections 141a. The boom pin receiving sections 141b support, respectively, the pair of boom coupling pins 15a. In the illustrated case, the pair of boom pin receiving sections 141b and the pair of cylinder pin receiving sections 141a are shifted from one another in axial direction of the telescopic boom 14, for convenience of explanation. However, the pair of boom pin receiving sections 141b and the pair of cylinder pin receiving sections 141a are aligned in the axial direction of the telescopic boom 14 and are provided at positions shifted in the circumferential direction of the telescopic boom 14.

Each of the pair of boom coupling pins 15a couples the distal end boom 141 to the intermediate boom 142. The pair of boom coupling pins 15a moves inward (in direction from the distal ends toward the proximal ends of the boom coupling pins 15a), based on actuation of a boom coupling mechanism 46 that will be described later. It should be noted that a specific structure of the pair of boom coupling pins 15a will be described later.

In a state where the distal end boom 141 is coupled to the intermediate boom 142 by the pair of boom coupling pins 15a, the boom coupling pins 15a are inserted into and pass through both the boom pin receiving sections 141b of the distal end boom 141 and first boom pin receiving sections 142b or the second boom pin receiving sections 142c of the intermediate boom 142 so as to bridge therebetween. In short, the pair of boom coupling pins 15a can engage with or disengage from, respectively, the first boom pin receiving sections 142b or the second boom pin receiving sections 142c of the intermediate boom 142.

The intermediate boom 142 has, at its proximal end, a pair of cylinder pin receiving sections 142a, the pair of first boom pin receiving sections 142b, and a pair of third boom pin receiving sections 142d and also has, at its distal end, the pair of second boom pin receiving sections 142c.

In the illustrated case, the pair of first boom pin receiving sections 142b and the pair of cylinder pin receiving sections 142a are shifted from one another in the axial direction of the telescopic boom 14, for convenience of explanation. However, the pair of first boom pin receiving sections 142b and the pair of cylinder pin receiving sections 142a are aligned in the axial direction of the telescopic boom 14 and are provided at positions shifted in the circumferential direction of the telescopic boom 14.

The pair of boom coupling pins 15b is inserted into and passes through, respectively, the pair of third boom pin receiving sections 142d. The pair of boom coupling pins 15b couples the intermediate boom 142 to the proximal end boom 143.

The pair of second boom pin receiving sections 142c are provided coaxially with each other at the distal end of the intermediate boom 142. The pair of boom coupling pins 15a is inserted into and passes through, respectively, the pair of second boom pin receiving sections 142c.

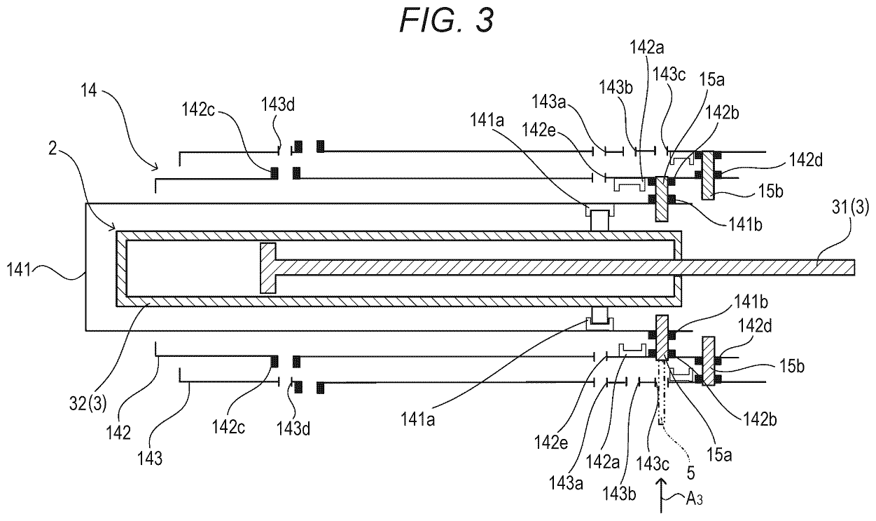

As illustrated in FIG. 3, the intermediate boom 142 has a pair of cylinder pin emergency operation holes 142e at positions coaxial with the pair of cylinder pin receiving sections 141a of the distal end boom 141 in the state where the telescopic boom 14 contracts. The proximal end boom 143 has a pair of cylinder pin emergency operation holes 143a at positions coaxial with the pair of cylinder pin receiving sections 141a of the distal end boom 141 in the state where the telescopic boom 14 contracts.

The proximal end boom 143 has a pair of cylinder pin emergency operation holes 143b at positions coaxial with the pair of cylinder pin receiving sections 142a of the intermediate boom 142 in the state where the telescopic boom 14 contracts.

When an operator performs a manual operation of manually moving the pair of cylinder coupling pins 454A and 454B, he/she can access, from the outside of the telescopic boom 14 via the cylinder pin emergency operation holes 142e, 143a, and 143b, the pairs of cylinder coupling pins 454A and 454B, which are engaging with the pair of cylinder pin receiving sections 141a of the distal end boom 141 or the pair of cylinder pin receiving sections 142a of the intermediate boom 142.

Furthermore, the intermediate boom 142 and the proximal end boom 143 have boom pin emergency operation holes 143c and 143d at positions coaxial with the boom pin receiving sections of all the booms disposed inside in the state where the telescopic boom 14 contracts. Since the illustrated telescopic boom 14 has a single intermediate boom, the boom pin emergency operation holes 143c and 143d are provided only in the proximal end boom 143. However, when a plurality of intermediate booms are present, boom pin emergency operation holes may be provided in the intermediate booms at appropriate positions.

When the operator performs a manual operation of manually moving boom coupling pins (e.g., the boom coupling pins 15a), he/she can access the boom coupling pins (e.g., the boom coupling pins 15a) from the outside of the telescopic boom 14 via the boom pin emergency operation holes 143c and 143d.

In the present embodiment, the cylinder pin emergency operation holes 143b and the boom pin emergency operation holes 143c and 143d are provided within the same plane of the boom. Therefore, when manually operating cylinder coupling pins and boom coupling pins, the operator can do the work from the same direction.

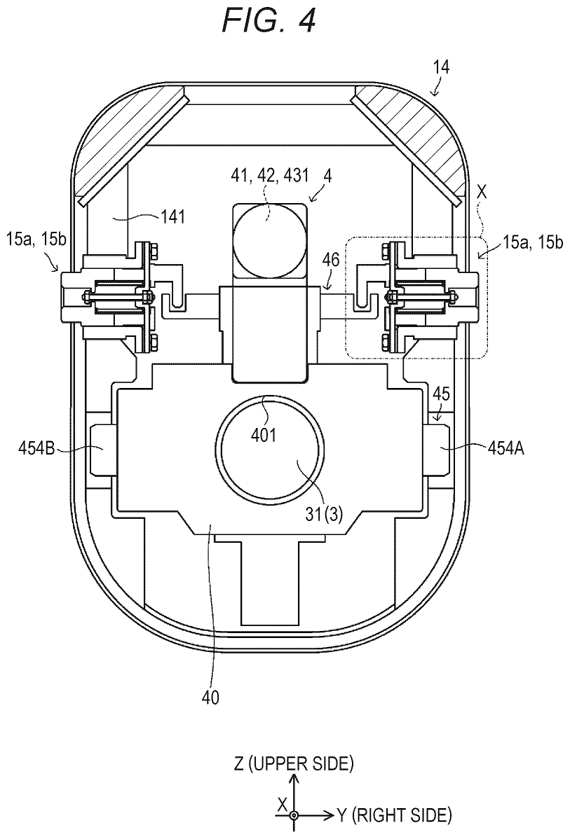

The actuator 2 is an actuator that extends and shortens the telescopic boom 14. As illustrated in FIGS. 2A to 2E and 4, the actuator 2 includes the telescopic cylinder 3 and a pin-moving mechanism 4. The actuator 2 is disposed in the inner space of the distal end boom 141 in the state where the telescopic boom 14 contracts (state illustrated in FIG. 2A).

The telescopic cylinder 3 includes a rod member 31 and the cylinder member 32. The telescopic cylinder 3 is used to move one or more booms coupled to the cylinder member 32 via the cylinder coupling pins 454A and 454B that will be described later.

The pin-moving mechanism 4 includes the electric motor 41, a brake mechanism 42, a transmission mechanism 43, a position information detection device 44, a cylinder coupling mechanism 45, and the boom coupling mechanism 46, all of which are supported by a trunnion 40.

Hereinafter, individual members constituting the actuator 2 will be described with reference to a state where the members are integrated into the actuator 2. In the description of the actuator 2, an orthogonal coordinate system (X, Y, Z) is used.

In the orthogonal coordinate system, the X direction coincide with the extending and shortening direction of the telescopic boom 14 mounted on the mobile crane 1. The +X direction is the extending direction, which is one of the extending and shortening direction. The −X direction is the contracting direction of the extending and contracting direction. When the turning angle of the telescopic boom 14 is 0° and the lifting angle of the telescopic boom 14 is 0° (in the fully folded state), the +X-directional side coincides with the front side of the mobile crane 1. When the turning angle of the telescopic boom 14 is 0° and the lifting angle of the telescopic boom 14 is 0°, the −X-directional side coincides with the rear side of the mobile crane 1.

The Z direction coincide with the upward and downward direction of the mobile crane 1, for example, in the state where the lifting angle of the telescopic boom 14 is 0°. The Y direction coincide with the vehicle width direction (right and left direction) of the mobile crane 1, for example, in a state where the telescopic boom 14 faces forward. Hereinafter, the width direction or the right and left direction mean the Y direction in the orthogonal coordinate system (X, Y, Z), unless otherwise specified.

The trunnion 40 is fixed to the cylinder member 32 of the telescopic cylinder 3. The trunnion 40 supports the cylinder coupling mechanism 45 and the boom coupling mechanism 46, as illustrated in FIG. 4. In addition, the trunnion 40 supports the electric motor 41, the brake mechanism 42, and the transmission mechanism 43. FIG. 4 is a cross-sectional view of the telescopic boom 14 and the pin-moving mechanism 4 taken along a plane (Z-Y plane) orthogonal to the extending or shortening direction of the telescopic boom 14. In FIG. 4, some of the members are omitted for convenience of description. In FIG. 4, the hatching indicating the cross section is also omitted.

The trunnion 40 integrates the elements 41 to 46 into a single unit. Such a configuration contributes to compactness of the pin-moving mechanism 4, improved productivity, and enhanced system reliability. In addition, the cylinder coupling mechanism 45, the boom coupling mechanism 46, and the electric motor 41 are arranged side by side in the vertical direction, especially in the present embodiment. This arrangement contributes to the compactness of the pin-moving mechanism 4 in the extending and shortening direction (X direction) of the telescopic boom 14.

The trunnion 40 has a support hole 401. The rod member 31 of the telescopic cylinder 3 is inserted into and passes through the support hole 401 in the X direction. The trunnion 40 is fixed to the proximal end (−X-directional end) of the cylinder member 32 of the telescopic cylinder 3. The trunnion 40 thereby can move together with the cylinder member 32.

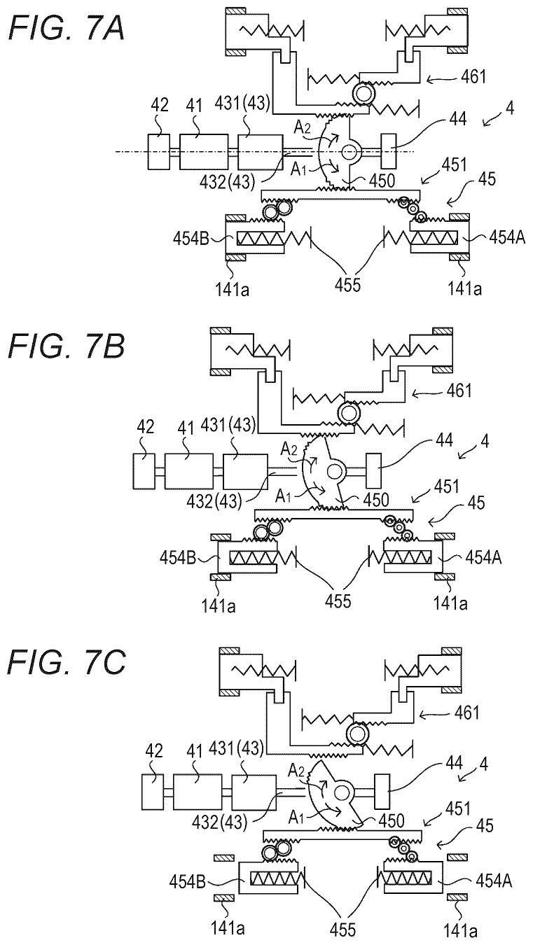

The electric motor 41 is supported by the trunnion 40 (see FIG. 4). More specifically, the electric motor 41 is supported by the upper side of the trunnion 40, with the output shaft thereof disposed in parallel to the extending and shortening direction (X direction) of the telescopic boom 14. As illustrated in FIG. 7A, the electric motor 41 is connected to a speed reducer 431. The electric motor 41 is connected to, for example, a power supply device (not illustrated) provided on the turning table 12 via a power supply cable.

The brake mechanism 42 applies braking force to the electric motor 41. The brake mechanism 42 prevents the output shaft of the electric motor 41 from rotating when the electric motor 41 stops. As a result, the state of the pin-moving mechanism 4 is maintained when the electric motor 41 stops. The speed reducer 431 and the brake mechanism 42 are provided coaxially with the electric motor 41.

More specifically, the brake mechanism 42 is activated in the state where the cylinder coupling mechanism 45 shortens or in the state where the boom coupling mechanism 46 shortens, which will be described later, thereby maintaining the state of the cylinder coupling mechanism 45 or the boom coupling mechanism 46. The state of the brake mechanism 42 is switched by a control section. Alternatively, the state of the brake mechanism 42 may be switched based on operator's operation.

The transmission mechanism 43 transmits the power of the electric motor 41 to the cylinder coupling mechanism 45 and the boom coupling mechanism 46. The transmission mechanism 43 has the speed reducer 431 and a transmission shaft 432.

The speed reducer 431 reduces the rotation speed of the electric motor 41 and then transmits the rotation to the transmission shaft 432. The transmission shaft 432 transmits the rotation of the speed reducer 431 to a switch gear 450 that will be described later. The distal end of the transmission shaft 432 is provided with the position information detection device 44, which detects information regarding the positions of the pair of cylinder coupling pins 454A and 454B and the pair of boom coupling pins 15a and 15b.

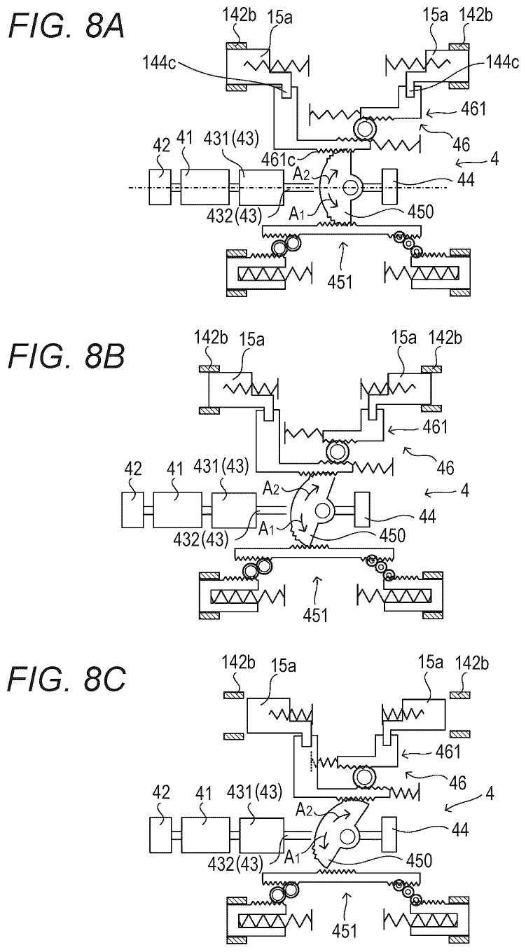

The information regarding the positions of the pair of cylinder coupling pins 454A and 454B and the pair of boom coupling pins 15a and 15b refers to, for example, a movement amount of the pair of cylinder coupling pins 454A and 454B or the pair of boom coupling pins 15a and 15b from reference positions. The positions of the pair of cylinder coupling pins 454A and 454B illustrated in FIG. 7A correspond to the reference positions of the cylinder coupling pins 454A and 454B. The positions of the pair of boom coupling pins 15a illustrated in FIG. 8A correspond to the reference positions of the boom coupling pins 15a.

The cylinder coupling mechanism 45 is activated based on the power of the electric motor 41 and transitions between the extending state (see FIG. 7A) and the contracting state (see FIG. 7C). The operation in which the cylinder coupling mechanism 45 transitions from the extending state to the contracting state corresponds to a removal operation to be performed by the cylinder coupling mechanism 45. The operation in which the cylinder coupling mechanism 45 transitions from the contracting state to the extending state corresponds to an insertion operation to be performed by the cylinder coupling mechanism 45.

When the cylinder coupling mechanism 45 is in the extending state, the pair of cylinder coupling pins 454A and 454B engages with the pair of cylinder pin receiving sections 141a of a boom (e.g., distal end boom 141). In this engaging state, the boom is coupled to the cylinder member 32.

When the cylinder coupling mechanism 45 is in the contracting state, the pair of cylinder coupling pins 454A and 454B disengages from the pair of cylinder pin receiving sections 141a. In this disengaging state, the engagement between the boom and the cylinder member 32 is released.

More specifically, the cylinder coupling mechanism 45 includes the switch gear 450, a first transmission mechanism 451, the pair of cylinder coupling pins 454A and 454B, and a first biasing mechanism 455.

The switch gear 450 is externally fitted into and fixed to the transmission shaft 432 and selectively transmits the power of the electric motor 41 to a coupling mechanism, which is one of the cylinder coupling mechanism 45 and the boom coupling mechanism 46.

Herein, a direction (direction indicated by arrow A₁ in FIG. 7A) in which the switch gear 450 rotates when the cylinder coupling mechanism 45 transitions from the extending state to the contracting state is defined as a first rotation direction of the switch gear 450. A direction (direction indicated by arrow A₂ in FIG. 7C) in which the switch gear 450 rotates when the cylinder coupling mechanism 45 transitions from the contracting state to the extending state is defined as a second rotation direction of the switch gear 450.

The first transmission mechanism 451 is formed of a rack bar or a gear, for example. The first transmission mechanism 451 transmits driving force related to the rotation of the switch gear 450 to the cylinder coupling pins 454A and 454B.

The pair of cylinder coupling pins 454A and 454B have respective central axes coinciding with and are coaxial with each other in the right and left direction. Each of the pair of cylinder coupling pins 454A and 454B is supported by the trunnion 40. The pair of cylinder coupling pins 454A and 454B is configured to be movable in its own axial direction, based on the power of the electric motor 41 or the biasing force of the first biasing mechanism 455.

The first biasing mechanism 455 is formed of a pair of coil springs and, when the electric motor 41 turns into a non-energized state while the cylinder coupling mechanism 45 is in the contracting state, returns the cylinder coupling mechanism 45 to the extending state.

When the switch gear 450 rotates in the first rotation direction based on the power of the electric motor 41 while the cylinder coupling mechanism 45 is in the extending state as illustrated in FIG. 7A, the first transmission mechanism 451 transmits driving force for moving the cylinder coupling pins 454A and 454B inward to the cylinder coupling pins 454A and 454B. As a result, the cylinder coupling mechanism 45 turns into the contracting state.

When the switch gear 450 rotates in the second rotation direction based on the biasing force of the first biasing mechanism 455 with the cylinder coupling mechanism 45 being in the contracting state as illustrated in FIG. 7C, the cylinder coupling mechanism 45 transmits the driving force for moving the cylinder coupling pins 454A and 454B outward to the cylinder coupling pins 454A and 454B. As a result, the cylinder coupling mechanism 45 turns into the extending state.

The boom coupling mechanism 46 transitions between the extending state (see FIG. 8A) and the contracting state (see FIG. 8C), based on the rotation of the electric motor 41. The operation in which the boom coupling mechanism 46 transitions from the extending state to the contracting state corresponds to the removal operation to be performed by the boom coupling mechanism 46. The operation in which the boom coupling mechanism 46 transitions from the contracting state to the extending state corresponds to the insertion operation to be performed by the boom coupling mechanism 46.

Each boom coupling pin 15a is a pin for use in coupling an inner boom (the distal end boom 141 or the intermediate boom 142) to an outer boom (intermediate boom 142 or proximal end boom 143). Each boom coupling pin 15a is supported by the inner boom. A specific configuration of each boom coupling pin 15a will be described later.

When being in the extending state, the boom coupling mechanism 46 can engage with boom coupling pins (e.g., the pair of boom coupling pins 15a). The boom coupling mechanism 46 transitions from the extending state to the contracting state while engaging with the boom coupling pins, thereby disengaging the boom coupling pins from the boom. In the following description, the boom coupling pins 15a will be described as an example of the boom coupling pins. The boom coupling pins may also be the boom coupling pins 15b.

The boom coupling mechanism 46 transitions from the contracting state to the extending state while engaging with the boom coupling pins 15a, thereby causing the boom coupling pins 15a to engage with the outer boom.

As illustrated in FIGS. 8A to 8C, the boom coupling mechanism 46 includes the switch gear 450 and a second transmission mechanism 461. The switch gear 450 is a gear shared by the cylinder coupling mechanism 45.

The second transmission mechanism 461 is formed of a rack bar or a gear, for example. While engaging with the boom coupling pins 15a, the second transmission mechanism 461 transmits the driving force related to the rotation of the switch gear 450 to the pair of boom coupling pins 15a. In short, the second transmission mechanism 461 simultaneously moves the pair of boom coupling pins 15a.

When the switch gear 450 rotates in second rotation direction A₂ while the boom coupling mechanism 46 is in the extending state (see FIG. 8A), the second transmission mechanism 461 moves the boom coupling pins 15a inward. Then, the boom coupling mechanism 46 turns into the contracting state (see FIG. 8C).

When the switch gear 450 rotates in first rotation direction A₁ while the boom coupling mechanism 46 is in the contracting state, the second transmission mechanism 461 moves the boom coupling pins 15a outward. Then, the boom coupling mechanism 46 turns into the extending state.

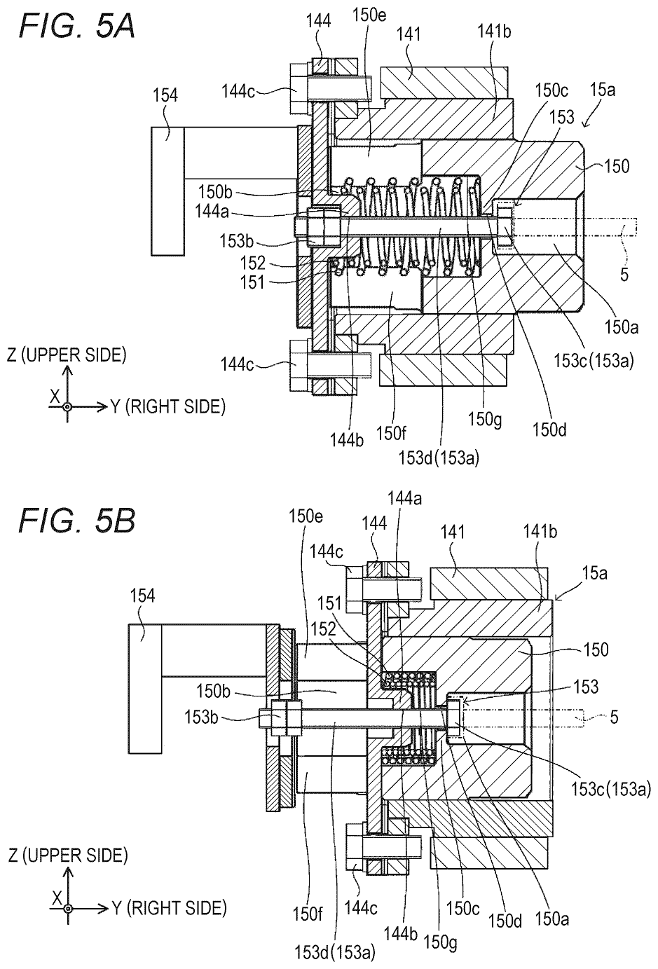

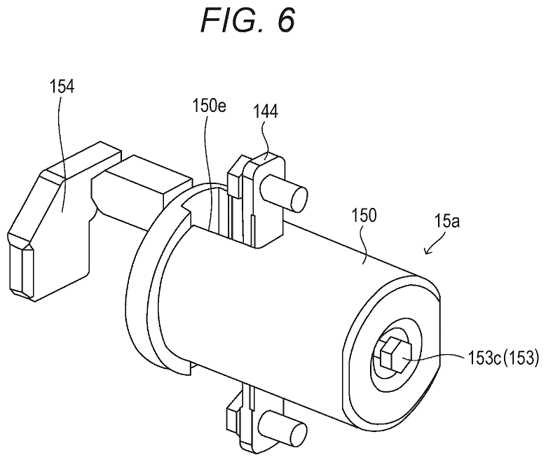

A structure of each boom coupling pin 15a will be described with reference to FIGS. 4 to 6. Each boom coupling pin 15a is configured to be movable in the axial direction. FIG. 5A illustrates a state where a boom coupling pin 15a is located on the outermost side (at one end in the movement stroke in the axial direction). The state where the boom coupling pin 15a is located on the outermost side is also referred to as the insertion state of the boom coupling pin 15a.

FIG. 5B illustrates a state where the boom coupling pin 15a is located at the innermost side (at the other end in the movement stroke in the axial direction). The state where the boom coupling pin 15a is located at the innermost side is also referred to as the removal state of the boom coupling pin 15a.

As illustrated in FIG. 2A and some other drawings, each of the inner booms (the distal end boom 141 and the intermediate boom 142 in the present embodiment) which is disposed inside the proximal end boom 143 is provided with a pair of boom coupling pins. All of the boom coupling pins have substantially the same configuration as the boom coupling pins 15a.

In the following description, of the pair of boom coupling pins 15a provided in the distal end boom 141, the right boom coupling pin 15a will be described. However, the configuration of the left boom coupling pin 15a of the pair of boom coupling pins 15a is substantially the same as that of the boom coupling pins 15a.

The boom coupling pin 15a includes a pin main body 150, a first coil spring 151, a second coil spring 152, a manual operation member 153, and a latch claw section 154.

The pin main body 150, which is a substantially cylindrical member, is configured to be movable in the axial direction. The pin main body 150 can also be regarded as the boom coupling pin.

In the following description, the distal end refers to one end (the right side in FIGS. 5A and 5B) of the pin main body 150 in the axial direction. The proximal end refers to the other end (the left side in FIGS. 5A and 5B) of the pin main body 150 in the axial direction. The one end of the pin main body 150 in the axial direction corresponds to the outer side of the mobile crane 1 in the vehicle width direction. The other end of the pin main body 150 in the axial direction corresponds to the inner side of the mobile crane 1 in the vehicle width direction. The axial direction of the pin main body 150 are also regarded as the moving direction of the boom coupling pin 15a. In the present embodiment, the axial direction of the pin main body 150 coincide with the right-left direction of the mobile crane 1. Alternatively, the axial direction of the pin main body 150 may coincide with the upward and downward direction of the mobile crane 1.

The pin main body 150 has a first storage section 150a in its half portion at the distal end (on the outer side). The distal end (outer end) of the first storage section 150a is exposed from a distal end surface (outer end surface) of the pin main body 150. The central axis of the first storage section 150a is parallel to the axial direction and coincides with the central axis of the pin main body 150.

The pin main body 150 has a second storage section 150b in its half portions at the proximal end (on the inner side). The central axis of the second storage section 150b is parallel to the axial direction and coincides with the central axis of the pin main body 150. Thus, the central axis of the second storage section 150b coincides with the central axis of the first storage section 150a. The first storage section 150a is separated from the second storage section 150b by a partition section 150c.

The partition section 150c, which has a planar shape, has a pin-side through-hole 150d formed across the partition section 150c in the axial direction. The central axis of the pin-side through-hole 150d coincides with the central axes of the first storage section 150a and the second storage section 150b.

The pin main body 150 has a pair of slits 150e and 150f at its proximal end. Each of the slits 150e and 150f is formed from the proximal end toward the distal end of the pin main body 150. The length of the slits 150e and 150f (the lengths of the pin main body 150 in the axial direction) is set in accordance with an axial movement stroke of the boom coupling pin 15a.

The slit 150e is provided on the upper side of the pin main body 150. The slit 150f is provided on the lower side of the pin main body 150. The slit 150e and the slit 150f are formed opposite each other in the vertical direction.

The pin main body 150 having the above configuration is held by the boom pin receiving section 141b of the distal end boom 141. The boom pin receiving section 141b is formed of a cylindrical sleeve fixed to the distal end boom 141. The boom pin receiving section 141b is fixed to the distal end boom 141 with welding.

Support members 144 are fixed to the boom pin receiving section 141b. Each of the support members 144, which is a planar member extending in the vertical direction, is fixed to the boom pin receiving section 141b via a fastening component, such as a bolt. More specifically, the support members 144, each of which is formed of a single planar member, are fixed to the boom pin receiving section 141b by fastening components 144c (bolts in the illustrated case) inserted into and passing through the upper portion and the lower portion.

Each support member 144 is a member that supports the pin main body 150 with respect to the boom. Each support member 144 is also a member that guides the movement of the pin main body 150 in the axial direction.

The support members 144 are inserted into and pass through the slits 150e and 150f of the pin main body 150 in the upward and downward direction. The width dimension of the support members 144 is slightly smaller than the width dimension of the slits 150e and 150f. The movement of the pin main body 150 in the axial direction is guided by the engagement between the support members 144 and the slits 150e and 150f.

In the present embodiment, the support members 144 are inserted into and pass through the slits 150e and 150f in the upward and downward direction. Such a configuration contributes to compactness of a structure that supports the boom coupling pin 15a on the boom pin receiving section 141b. In addition, the fastening components 144c that fix the support members 144 to the boom pin receiving sections 141b are provided above and below the pin main body 150. Therefore, when the boom coupling mechanism 46 engages with the latch claw section 154 of the boom coupling pin 15a from the extending or shortening direction (X direction) in the state illustrated in FIG. 5A, the boom coupling mechanism 46 and the fastening component 144c do not interfere with each other. Thus, by providing the fastening components 144c above and below the pin main body 150, the interference can be suppressed without provision of a space used to avoid the interference between the boom coupling mechanism 46 and the fastening component 144c in the extending and shortening direction. As a result, it is possible to downsize the structure that supports the boom coupling pin on the boom pin receiving section 141b. In the present embodiment, the boom coupling pins 15a and 15b are attached to the telescopic boom 14 from the inside of the telescopic boom 14. Therefore, it is unnecessary to disassemble the telescopic boom 14 during the work in which the boom coupling pins 15a and 15b are attached to the telescopic boom 14.

Each support member 144 has a boss section 144a at its center in the vertical direction. The boss section 144a protrudes from one side surface (outer-side surface) of each support member 144 toward one side (outer side) of each support member 144 in the plate thickness direction. In this case, the plate thickness direction of each support member 144 coincide with the axial direction of the pin main body 150 and the vehicle width direction of the mobile crane 1.

The boss section 144a has a support-side screw hole 144b on its distal side. The central axis of the support-side screw hole 144b coincides with the central axis of the pin-side through-hole 150d. The inner circumferential surface of the support-side screw hole 144b is provided with a female screw section. The boss section 144a is disposed on a proximal end of the second storage section 150b of the pin main body 150, in the state where the boom coupling pin 15a is inserted (in the state illustrated in FIG. 5A).

The boss section 144a configured above is a member for use in positioning (guiding) the first coil spring 151 and the second coil spring 152 as described later and is also a member for use in storing a nut 153b of the manual operation member 153 inside.

Each of the first coil spring 151 and the second coil spring 152 is a biasing member for use in causing the boom coupling mechanism 46 to transition from the contracting state to the extending state during regular operation of the boom coupling mechanism 46. In other words, each of the first coil spring 151 and the second coil spring 152 is a biasing member that causes the boom coupling pin 15a to transition from the removal state to the insertion state during the regular operation of the boom coupling mechanism 46.

The first coil spring 151 and the second coil spring 152 are disposed in the second storage section 150b of the pin main body 150. The outer diameter of the first coil spring 151 is larger than the outer diameter of the second coil spring 152. The second coil spring 152 is disposed on the inner side of the first coil spring 151.

In other words, the first coil spring 151 and the second coil spring 152 are disposed between each support member 144 and the pin main body 150. More specifically, the distal ends (one end in the axial direction) of the first coil spring 151 and the second coil spring 152 are in contact with the pin main body 150 (more specifically, the partition section 150c). The outer circumferential surface of the distal end of the first coil spring 151 is held by the inner circumferential surface of a depression section 150g provided at the proximal end of the pin main body 150. With such a configuration, the compression of the first coil spring 151 is guided by the inner circumferential surface of the depression section 150g. In addition, the outer circumferential surface of the distal end of the second coil spring 152 is held by the first coil spring 151.

The proximal ends (other ends in the axial direction) of the first coil spring 151 and the second coil spring 152 are in contact with the support members 144. The proximal ends of the first coil spring 151 and the second coil spring 152 are disposed so as to surround the boss section 144a.

The first coil spring 151 and the second coil spring 152 are positioned by the boss section 144a. The first coil spring 151 and the second coil spring 152 configured above continuously bias the pin main body 150 in the insertion direction (toward one side in the axial direction).

The manual operation member 153 is a member to be operated by the operator during the manual operation. The manual operation member 153 is operated, for example, with a manual operation tool 5 to be used by an operator. The manual operation member 153 is inserted into and passes through the pin main body 150 and disposed coaxially with the pin main body 150. When the manual operation member 153 is rotated, the pin main body 150 moves in the removal direction (toward the other side in the axial direction) together with the manual operation member 153, so that the coupling between the adjacent booms is released. More specifically, when the manual operation member 153 is rotated, the manual operation member 153 presses the pin main body 150 in the removal direction. The pin main body 150 then moves in the removal direction to release the coupling between adjacent booms. In the present embodiment, the manual operation member 153, which is a member that presses the pin main body 150 in the removal direction during the manual operation, is continuously integrated into the boom coupling pin 15a. In short, the manual operation member 153 is continuously supported by the boom coupling pin 15a. Such a configuration can prevent the manual operation member 153 from being lost. The manual operation tool 5 is a socket wrench, for example. The length of the socket wrench may be adjusted as appropriate by an extension bar in accordance with the position of the boom coupling pin to be operated. The type of the manual operation tool may be determined as appropriate in accordance with the shape of the head section of the manual operation member.

More specifically, the manual operation member 153 includes a bolt 153a and the nut 153b. The bolt 153a includes a head section 153c and a screw shaft section 153d.

The outer circumferential surface of the screw shaft section 153d is provided with a male screw section. The screw shaft section 153d is inserted into and passes through the pin-side through-hole 150d and the support-side screw hole 144b. The central axis of the screw shaft section 153d coincides with the central axes of the pin-side through-hole 150d and the support-side screw hole 144b.

The male screw section of the screw shaft section 153d is screwed into the female screw section of the support-side screw hole 144b. One end (outer end) of the screw shaft section 153d in the axial direction protrudes toward one side (right side in FIGS. 5A and 5B) in the axial direction from the pin-side through-hole 150d (partition section 150c). In short, the end (outer end) of the screw shaft section 153d in the axial direction is disposed in the first storage section 150a of the pin main body 150.

The other end (inner end) of the screw shaft section 153d in the axial direction protrudes toward the other side (inner side or left side in FIGS. 5A and 5B) in the axial direction from the support-side screw hole 144b (the boss section 144a of each support member 144).

The head section 153c is provided at one end (outer end) of the screw shaft section 153d in the axial direction. Thus, the head section 153c is provided on the one side (the right side in FIGS. 5A and 5B) of the pin-side through-hole 150d (partition section 150c) in the axial direction. In short, the head section 153c is disposed in the first storage section 150a of the pin main body 150. The head section 153c, which corresponds to an example of a pressing section, is a member that presses the pin main body 150 in the removal direction during the manual operation.

The nut 153b, which is a so-called double nut, is fixed to the other end (inner end) of the screw shaft section 153d in the axial direction. Thus, the nut 153b is disposed on the other side (the left side in FIGS. 5A and 5B) of the support-side screw hole 144b (the boss section 144a of each support member 144) in the axial direction. When the boom coupling pin 15a is in the insertion state (state illustrated in FIG. 5A), the nut 153b is disposed on the inner side of the boss section 144a (left side in FIGS. 5A and 5B).

The manual operation member 153 having the above configuration constitutes, together with the support-side screw hole 144b, a conversion mechanism that can convert its own rotational motion into linear motion in the axial direction. When the manual operation member 153 is rotated in a predetermined direction, the manual operation member 153 moves in a predetermined direction of the axial direction.

The latch claw section 154 is fixed to the proximal end of the pin main body 150. The latch claw section 154 is configured to be able to be coupled to the boom coupling mechanism 46.

Hereinafter, an example of the operation of the boom coupling mechanism 46 will be described. First, an example of the regular operation of the boom coupling mechanism 46 will be described with reference to FIGS. 2A to 2E, 5A, and 8A to 8C.

FIG. 8A is a schematic view illustrating the extending state of the boom coupling mechanism 46 and the state where the pair of boom coupling pins 15a engages with the pair of first boom pin receiving sections 142b of the intermediate boom 142. FIG. 8B is a schematic view illustrating a state in the middle of the transition from the extending state to the contracting state of the boom coupling mechanism 46. Furthermore, FIG. 8C is a schematic view illustrating the contracting state of the boom coupling mechanism 46 and the state where the pair of boom coupling pins 15a has disengaged from the pair of first boom pin receiving sections 142b of the intermediate boom 142.

The extending state of the boom coupling mechanism 46 illustrated in FIG. 8A is related to the state of the boom coupling mechanism 46 in FIG. 2A. In this case, the state of the boom coupling pins 15a related to the extending state of the boom coupling mechanism 46 illustrated in FIG. 8A is the insertion state. FIG. 5A illustrates the boom coupling pin 15a in the insertion state.

The state of the boom coupling mechanism 46 illustrated in FIG. 8B is related to the state in the middle of the transition from the state of the boom coupling mechanism 46 illustrated in FIG. 2A to the state of the boom coupling mechanism 46 illustrated in FIG. 2B.

The contracting state of the boom coupling mechanism 46 illustrated in FIG. 8C is related to the state of the boom coupling mechanism 46 illustrated in FIG. 2B. The state of the boom coupling pins 15a is related to the contracting state of the boom coupling mechanism 46 illustrated in FIG. 8C is the removal state.

The boom coupling mechanism 46 transitions between the extending state and the contracting state, based on the power of the electric motor 41. In this case, the position of the switch gear 450 illustrated in FIG. 8A is defined as the reference position of the switch gear 450.

When the boom coupling mechanism 46 transitions from the extending state to the contracting state, the control section (not illustrated) drives the electric motor 41 in the direction opposite to the direction in which the cylinder coupling mechanism 45 is activated.

The power of the electric motor 41 is transmitted to the pair of boom coupling pins 15a via the switch gear 450 and the second transmission mechanism 461.

When the state transitions from the extending state to the contracting state with the second transmission mechanism 461 engaging with the pair of boom coupling pins 15a, the pair of boom coupling pins 15a disengages from the pair of first boom pin receiving sections 142b of the intermediate boom 142 (refer to FIG. 8C).

More specifically, when the switch gear 450 rotates in the second rotation direction (the direction indicated by arrow A₂ in FIG. 8A), based on the power of the electric motor 41, the right boom coupling pin 15a moves leftward, whereas the left boom coupling pin 15a moves toward the rightward. In this case, the moving direction of the pair of boom coupling pins 15a are removal direction of each of the boom coupling pins 15a.

In other words, when the state transitions from the extending state to the contracting state with the second transmission mechanism 461 engaging with the pair of boom coupling pins 15a, the pair of boom coupling pins 15a transitions from the insertion state to the removal state illustrated in FIG. 5A.

In the insertion state, the latch claw section 154 of the boom coupling pin 15a engages with the second transmission mechanism 461. In this state, when the latch claw section 154 is pulled leftward in FIG. 5A by the second transmission mechanism 461, the pin main body 150 moves leftward from the position illustrated in FIG. 5A. In this case, the pin main body 150 moves leftward against the biasing force of the first coil spring 151 and the second coil spring 152. However, the manual operation member 153 does not move from the position illustrated in FIG. 5A.

The position information detection device 44 detects that the pair of boom coupling pins 15a has disengaged from the pair of first boom pin receiving sections 142b of the intermediate boom 142 and moved to predetermined positions (e.g., the positions illustrated in FIG. 8C). Based on the detection result, the control section then stops the operation of the electric motor 41.

When the brake mechanism 42 is turned off with the electric motor 41 being non-energized, the insertion operation of the boom coupling mechanism 46 is automatically performed based on the biasing force of the first coil spring 151 and the second coil spring 152. During this state transition, the pair of boom coupling pins 15a moves away from each other.

The position information detection device 44 detects that the pair of boom coupling pins 15a has engaged with the pair of first boom pin receiving sections 142b of the intermediate boom 142 and moved to predetermined positions (e.g., the positions illustrated in FIG. 8C). The detection result is used to control the subsequent operation of the actuator 2.

Next, the operation of the boom coupling mechanism 46 in case of emergency will be described. If trouble (referred to below as “motor-related trouble”, such as power loss) in which the electric motor 41 fails to operate properly occurs while the boom coupling mechanism 46 is in the extending state illustrated in FIGS. 2A, 3, 5A, and 8A, the boom coupling mechanism 46 cannot transition from the extending state to the contracting state.

In the present embodiment, the operator can perform a manual operation to cause the boom coupling mechanism 46 to transition from the extending state to the contracting state. In other words, the operator can perform the manual operation to cause the pair of boom coupling pins 15a to transition from the insertion state to the removal state. Hereinafter, the reason for this will be described.

When the motor-related trouble occurs in the state illustrated in FIGS. 2A, 5A, and 8A, the operator inserts the manual operation tool 5 (see FIGS. 3 and 5A) into a boom pin emergency operation hole 143c (see FIG. 3) from the outside of the telescopic boom 14. The operator then causes the manual operation tool 5 to engage with the manual operation member 153 in the boom coupling pin 15a. More specifically, the manual operation tool 5 engages with the head section 153c in the manual operation member 153.

The operator then rotates the manual operation tool 5 in a predetermined direction (first direction). In response, the manual operation member 153 rotates together with the manual operation tool 5. When the manual operation member 153 rotates, the manual operation member 153 moves in an axial direction (toward the left side in FIG. 5A, or in a direction in which the boom coupling pin 15a is to be removed), based on the screwing between the screw shaft section 153d of the manual operation member 153 and the support-side screw hole 144b of the support member 144.

When the manual operation member 153 moves in the axial direction, the head section 153c presses the pin main body 150 (more specifically, the partition section 150c) in the direction in which the boom coupling pin 15a is to be removed. As a result, the pin main body 150 moves in the direction (toward the left side in FIG. 5A) in which the boom coupling pin 15a is to be removed, against the biasing force of the first coil spring 151 and the second coil spring 152.

When the operator continuously rotates the manual operation tool 5 in the predetermined direction (first direction), the depth ends (one end in the axial direction, or the right end in FIGS. 5A and 5B) of the slits 150e and 150f of the pin main body 150 come into contact with the support members 144 in the axial direction. In this state, the boom coupling pins 15a turn into the removal state illustrated in FIG. 5B. The engagement between each boom coupling pin 15a and the intermediate boom 142 is thereby released. In this case, the movement of the pin main body 150 in the insertion direction is restricted by the contact between the depth end of each of the slits 150e and 150f and the support members 144.

The right boom coupling pin 15a is connected to the left boom coupling pin 15a via the boom coupling mechanism 46. When the operator performs the manual operation, as described above, on the boom coupling pin 15a of one of the right boom coupling pin 15a and the left boom coupling pin 15a, the other boom coupling pin 15a also moves in the removal direction in synchronization with the one boom coupling pin 15a. As a result, both the right boom coupling pin 15a and the left boom coupling pin 15a simultaneously transition from the insertion state to the removal state.

When the operator rotates the manual operation tool 5 in a direction (second direction) opposite to the predetermined direction (first direction) in the state illustrated in FIG. 5B, the boom coupling pins 15a move in the insertion direction to turn into the insertion state illustrated in FIG. 5A.

Although not illustrated, the mobile crane according to the present embodiment also includes a mechanism (cylinder pin manual operation mechanism) for releasing the coupling between the telescopic cylinder 3 and the boom in response to manual operation. The operator can operate the cylinder pin manual operation mechanism with a tool that has been inserted into the cylinder pin emergency operation hole 143b, thereby successfully releasing the coupling between the telescopic cylinder 3 and each boom.

In the present embodiment, the cylinder pin emergency operation hole 143b and the boom pin emergency operation holes 143c and 143d are provided on the same surface in the boom. Thus, the operator can perform the manual operation of releasing the coupling between the telescopic cylinder 3 and each boom and the manual operation of releasing the coupling between the booms from the same direction (i.e., the direction indicated by arrow A₃ in FIG. 3). Such a configuration contributes to improvement in operability of manual operation.

### Effects of Present Embodiment

Even if the motor-related trouble occurs in the mobile crane 1 of the present embodiment which has the above configuration, as described above, the operator can perform a manual operation to cause the boom coupling pins 15a to transition from the insertion state to the removal state, thereby successfully manually releasing the coupling between adjacent booms.

In the present embodiment, the manual operation member 153 is disposed coaxially with the pin main body 150. Thus, when the operator manually operates the manual operation member 153, the force by which the pin main body 150 would be angled is less likely to act on the pin main body 150. As a result, it is possible to suppress the pin main body 150 from being angled. Therefore, it is possible to reduce the operating force during the manual operation and to stably move the pin main body 150 in the axial direction.

### Supplementary Notes

The technical idea disclosed in the specification and the drawings includes an invention obtained by arbitrarily combining various configurations described in the above-described embodiments. In particular, the technical idea disclosed in the specification and the drawings includes an invention obtained by applying various configurations disclosed in the specification and the drawings to the basic configuration in any combination.

This application is based upon and claims the benefit of priority from Japanese Patent Application No. 2022-98298, filed on Jun. 17, 2022, the entire contents of which are incorporated herein by reference.

### INDUSTRIAL APPLICABILITY

The present invention is not limited to mobile cranes and is applicable to various work machines (e.g., high-place work vehicles) equipped with telescopic booms.

### REFERENCE SIGNS LIST

1 mobile crane
10 traveling body
12 turning table
14 telescopic boom
141 distal end boom
141a cylinder pin receiving section
141b boom pin receiving section
142 intermediate boom
142a cylinder pin receiving section
142b first boom pin receiving section
142c second boom pin receiving section
142d third boom pin receiving section
142e cylinder pin emergency operation hole
143 proximal end boom
143a, 143b cylinder pin emergency operation hole
143c, 143d boom pin emergency operation hole
144 support member
144a boss section
144b support-side screw hole
144c fastening component
15a, 15b boom coupling pin
150 pin main body
150a first storage section
150b second storage section
150c partition section
150d pin-side through-hole
150e, 150f slit
150g depression section
151 first coil spring
152 second coil spring
153 manual operation member
153a bolt
153b nut
153c head section
153d screw shaft section
154 latch claw section
16 wire rope
17 hook
2 actuator
3 telescopic cylinder
31 rod member
32 cylinder member
4 pin-moving mechanism
40 trunnion
401 support hole
41 electric motor
42 brake mechanism
43 transmission mechanism
431 speed reducer
432 transmission shaft
44 position information detection device
45 cylinder coupling mechanism
450 switch gear
451 first transmission mechanism
454A, 454B cylinder coupling pin
455 first biasing mechanism
46 boom coupling mechanism
461 second transmission mechanism
5 manual operation tool

1. A work machine comprising:
a plurality of booms that extend and shorten by power of an actuator;
a boom coupling pin that is moved in an insertion direction by a spring to turn into an insertion state where adjacent ones of the booms make a coupling with each other and that is moved in a removal direction by power of a motor to turn into a removal state where the coupling is released, the boom coupling pin being supported by the booms; and
a manual operation member that is inserted into and passes through the boom coupling pin, the manual operation member being disposed coaxially with the boom coupling pin, wherein
when the manual operation member is rotated based on an operator's manual operation, the boom coupling pin moves in the removal direction together with the manual operation member to release the coupling between the adjacent booms.

2. The work machine according to claim 1, further comprising a support member having a support-side screw hole, the support member supporting the boom coupling pin on the booms, wherein
the manual operation member makes a screw coupling with the support-side screw hole and is configured to be able to convert, based on the screw coupling, rotation of the manual operation member into movement thereof in the removal direction.

3. The work machine according to claim 2, wherein the spring is disposed between the support member and the boom coupling pin and continuously biases the boom coupling pin in the insertion direction.

4. The work machine according to claim 3, wherein the support member includes a boss section in which the support-side screw hole is formed, the boss section positioning the spring, the boss section being able to store inside a nut provided at a distal end of the manual operation member.

5. The work machine according to claim 2, wherein
the boom coupling pin has a proximal end at which a pair of slits is formed,
the support member is inserted into and pass through the slits, and
movement of the boom coupling pin is guided based on engagement between each of the slits and the support member.

6. The work machine according to claim 5, wherein the boom coupling pin is configured to be movable in the removal direction to a position at which each slit and the support member come into contact with each other in an axial direction of the boom coupling pin.

7. The work machine according to claim 5, wherein
the pair of slits is provided on an upper end portion and a lower end portion of the boom coupling pin, and
the support member has an upper end portion and a lower end portion fixed to the booms via a fastening component and is inserted into and passes through the pair of slits from an upward and downward direction.

8. The work machine according to claim 1, further comprising a boom coupling mechanism configured to switch the boom coupling pin between the insertion state and the removal state, wherein
the boom coupling pin includes a pair of pins to be moved in synchronization with each other by the boom coupling mechanism, and
when one of the pair of pins is manually operated while the pair of pins engages with the boom coupling mechanism, the pair of pins simultaneously moves in the removal direction of each of the pins.

9. The work machine according to claim 1, wherein the manual operation member includes a pressing section via which the boom coupling pin is to be pressed in the removal direction.

10. The work machine according to claim 9, wherein the manual operation member is continuously integrated into the boom coupling pin.
